(19) United States
(12) Patent Application Publication
(10) Pub. No.: US 2019/0065160 A1
(43) Pub. Date: Feb. 28, 2019

(54) PRE-POST RETIRE HYBRID HARDWARE LOCK ELISION (HLE) SCHEME

(71) Applicants: Haitham Akkary, Portland, OR (US); Shlomo Raikin, Geva Carmel (IL); Ravi Rajwar, Portland, OR (US); Gad Sheaffer, Haifa (IL); Srikanth T. Srinivasan, Portland, OR (US)

(72) Inventors: Haitham Akkary, Portland, OR (US); Shlomo Raikin, Geva Carmel (IL); Ravi Rajwar, Portland, OR (US); Gad Sheaffer, Haifa (IL); Srikanth T. Srinivasan, Portland, OR (US)

(21) Appl. No.: 11/936,243

(22) Filed: Nov. 7, 2007

(51) Int. Cl. G06F 8/41

(52) U.S. Cl. CPC G06F 8/41

(57) ABSTRACT

A method and apparatus for hybrid pre and post-retire tentative access tracking is herein described. Access tracking is often performed during execution of critical sections, which may be defined by traditional locks or transactional memory instructions. Pre-retire accesses to memory are performed to update tracking information for access during execution of a critical section. However, post-retire updates to tracking information are performed for subsequent consecutive critical section accesses in a pipeline when a previous end critical section operation is retired.

### FIELD

This invention relates to the field of processor execution and, in particular, to tracking memory accesses during execution.

### BACKGROUND

Advances in semi-conductor processing and logic design have permitted an increase in the amount of logic that may be present on integrated circuit devices. As a result, computer system configurations have evolved from a single or multiple integrated circuits in a system to multiple cores and multiple logical processors present on individual integrated circuits. A processor or integrated circuit typically comprises a single processor die, where the processor die may include any number of cores or logical processors.

The ever increasing number of cores and logical processors on integrated circuits enables more software threads to be executed. However, the increase in the number of software threads that may be executed simultaneously has created problems with synchronizing data shared among the software threads. One common solution to accessing shared data in multiple core or multiple logical processor systems comprises the use of locks to guarantee mutual exclusion across multiple accesses to shared data. However, the ever increasing ability to execute multiple software threads potentially results in false contention and a serialization of execution.

For example, consider a hash table holding shared data. With a lock system, a programmer may lock the entire hash table, allowing one thread to access the entire hash table. However, throughput and performance of other threads is potentially adversely affected, as they are unable to access any entries in the hash table, until the lock is released. Alternatively, each entry in the hash table may be locked. However, this increases programming complexity, as programmers have to account for more locks within a hashtable.

Another data synchronization technique includes the use of transactional memory (TM). Often transactional execution includes speculatively executing a grouping of a plurality of micro-operations, operations, or instructions. In the example above, both threads execute within the hash table, and their accesses are monitored/tracked. If both threads access/alter the same entry, one of the transactions may be aborted to resolve the conflict. However, some applications may not take advantage of transactional memory programming. As a result, a hardware data synchronization technique, which is often referred to Hardware Lock Elision (HLE), is utilized to elide locks to obtain synchronization benefits similar to transactional memory. Therefore, problems for tracking memory accesses efficiently often arises for execution of critical sections of code through use of transactional memory and HLE.

### BRIEF DESCRIPTION OF THE DRAWINGS

The present invention is illustrated by way of example and not intended to be limited by the figures of the accompanying drawings.

FIG. 1 illustrates an embodiment of a multi-processing element processor capable of performing pre-retire and post-retire memory access tracking.

FIG. 2 illustrates an embodiment of tracking logic to perform post-retire access tracking for consecutive critical section memory accesses.

FIG. 3 illustrates an embodiment of a flow diagram for a method of performing pre-retire and post-retire access tracking.

FIG. 4A illustrates an embodiment of a flow diagram for a method of tracking the start of critical sections.

FIG. 4B illustrates an embodiment of a flow diagram for a method of tracking the end of critical sections.

FIG. 4C illustrates an embodiment of a flow diagram for a method of performing pre-retire and post-retire access tracking.

FIG. 5 illustrates an exemplary critical section timeline.

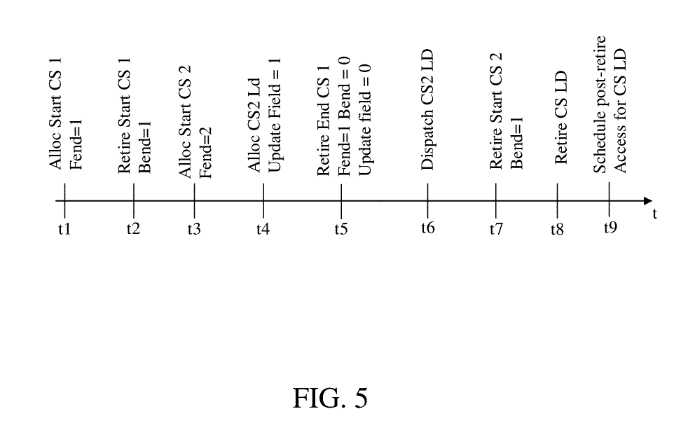

### DETAILED DESCRIPTION

In the following description, numerous specific details are set forth such as examples of specific hardware support for Hardware Lock Elision (HLE), specific tracking/meta-data methods, specific types of local/memory in processors, and specific types of memory accesses and locations, etc. in order to provide a thorough understanding of the present invention. It will be apparent, however, to one skilled in the art that these specific details need not be employed to practice the present invention. In other instances, well known components or methods, such as coding of critical sections in software, demarcation of critical sections, specific multi-core and multi-threaded processor architectures, interrupt generation/handling, cache organizations, and specific operational details of microprocessors, have not been described in detail in order to avoid unnecessarily obscuring the present invention.

The method and apparatus described herein are for a hybrid pre-retire and post-retire tracking of tentative accesses during execution of critical sections. Specifically, the hybrid scheme is primarily discussed in reference to multi-core processor computer systems. However, the methods and apparatus for hybrid access tracking are not so limited, as they may be implemented on or in association with any integrated circuit device or system, such as cell phones, personal digital assistants, embedded controllers, mobile platforms, desktop platforms, and server platforms, as well as in conjunction with other resources, such as hardware/software threads, that execute critical sections. Furthermore, the hybrid scheme is primarily also discussed in reference to access tracking during HLE. Yet, hybrid memory access tracking may be utilized during any memory access scheme, such as during transactional execution.

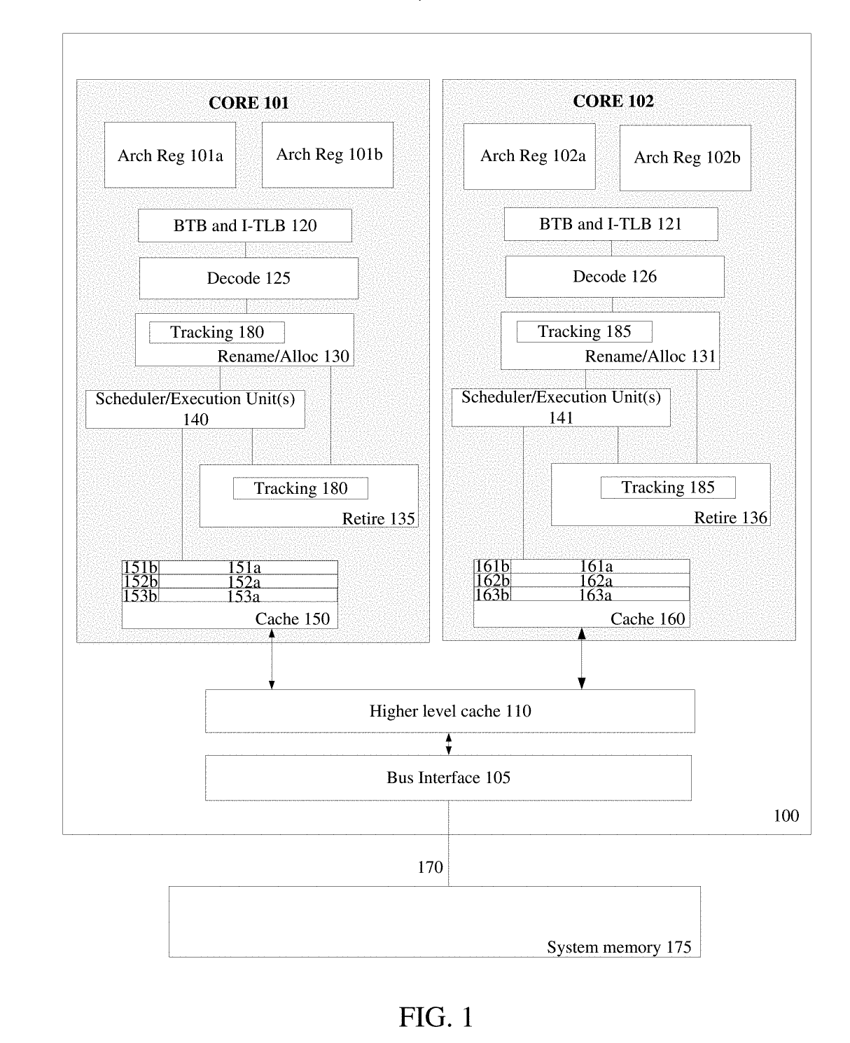

Referring to FIG. 1, an embodiment of multi-core processor 100, which is capable of performing hybrid pre-retire and post-retire access tracking, is illustrated. As shown, physical processor 100 includes any number of processing elements. A processing element refers to a thread, a process, a context, a logical processor, a hardware thread, a core, and/or any processing element, which potentially shares access to resources of the processor, such as reservation units, execution units, pipelines, and higher level caches/memory. A physical processor typically refers to an integrated circuit, which may include any number of processing elements, such as cores or hardware threads.

A core often refers to logic located on an integrated circuit capable of maintaining an independent architectural state wherein each independently maintained architectural state is associated with at least some dedicated execution resources. In contrast to cores, a hardware thread typically refers to any logic located on an integrated circuit capable of maintaining an independent architectural state wherein the independently maintained architectural states share access to execution resources. Physical processor 100, as illustrated in FIG. 1, includes two cores, core 101 and 102, which share access to higher level cache 110. In addition, core 101 includes two hardware threads 101a and 101b, while core 102 includes two hardware threads 102a and 102b. Therefore, software entities, such as an operating system or application, potentially view processor 100 as four separate processors, while processor 100 is capable of executing four software threads.

As can be seen, when certain resources are shared and others are dedicated to an architectural state, the line between the nomenclature of a hardware thread and core overlaps. Yet often, a core and a hardware thread are viewed by an operating system as individual logical processors, where the operating system is able to individually schedule operations on each logical processor. Therefore, a processing element includes any of the aforementioned entities capable of maintaining a context, such as cores, threads, hardware threads, virtual machines, or other resources.

In one embodiment, processor 100 is a multi-core processor capable of executing multiple threads in parallel. Here, a first thread is associated with architecture state registers 101a, a second thread is associated with architecture state registers 101b, a third thread is associated with architecture state registers 102a, and a fourth thread is associated with architecture state registers 102b. Reference to processing elements in processor 100, in one embodiment, includes reference to cores 101 and 102, as well as threads 101a, 101b, 102a, and 102b. In another embodiment, a processing element refers to elements at the same level in a hierarchy of processing domain. For example, core 101 and 102 are in the same domain level, threads 101a and 101b are on the same domain level within core 101, and threads 101a, 101b, 102a, and 102b are in the same domain level.

Although processor 100 may include asymmetric cores, i.e. cores with different configurations, functional units, and/or logic, symmetric cores are illustrated. As a result, core 102, which is illustrated as identical to core 101, will not be discussed in detail to avoid obscuring the discussion.

As illustrated, architecture state registers 101a are replicated in architecture state registers 101b, so individual architecture states/contexts are capable of being stored for logical processor 101a and logical processor 101b. Other smaller resources, such as instruction pointers and renaming logic in rename allocater logic 130 may also be replicated for threads 101a and 101b. Some resources, such as re-order buffers in reorder/retirement unit 135, ILTB 120, load/store buffers, and queues may be shared through partitioning. Other resources, such as general purpose internal registers, page-table base register, low-level data-cache and data-TLB 110, execution unit(s) 140, and out-of-order unit 135 are potentially fully shared.

Bus interface module 152 is to communicate with devices external to processor 100, such as system memory 175, a chipset, a northbridge, or other integrated circuit. Memory 175 may be dedicated to processor 100 or shared with other devices in a system. Examples of memory 175 includes dynamic random access memory (DRAM), static RAM (SRAM), non-volatile memory (NV memory), and long-term storage.

Typically bus interface unit 152 includes input/output (I/O) buffers to transmit and receive bus signals on interconnect 170. Examples of interconnect 170 include a Gunning Transceiver Logic (GTL) bus, a GTL+bus, a double data rate (DDR) bus, a pumped bus, a differential bus, a cache coherent bus, a point-to-point bus, a multi-drop bus or other known interconnect implementing any known bus protocol. Bus interface unit 152 as shown is also to communicate with higher level cache 110.

Higher-level or further-out cache 110 is to cache recently fetched and/or operated on elements. Note that higher-level or further-out refers to cache levels increasing or getting further way from the execution unit(s). In one embodiment, higher-level cache 110 is a second-level data cache. However, higher level cache 110 is not so limited, as it may be or include an instruction cache, which may also be referred to as a trace cache. A trace cache may instead be coupled after decoder 125 to store recently decode traces. Module 120 also potentially includes a branch target buffer to predict branches to be executed/taken and an instruction-translation buffer (I-TLB) to store address translation entries for instructions. Here, a processor capable of speculative execution potentially prefetches and speculatively executes predicted branches.

Decode module 125 is coupled to fetch unit 120 to decode fetched elements. In one embodiment, processor 100 is associated with an Instruction Set Architecture (ISA), which defines/specifies instructions executable on processor 100. Here, often machine code instructions recognized by the ISA include a portion of the instruction referred to as an opcode, which references/specifies an instruction or operation to be performed.

In one example, allocator and renamer block 130 includes an allocator to reserve resources, such as register files to store instruction processing results. However, threads 101a and 101b are potentially capable of out-of-order execution, where allocator and renamer block 130 also reserves other resources, such as reorder buffers to track instruction results. Unit 130 may also include a register renamer to rename program/instruction reference registers to other registers internal to processor 100. As illustrated, tracking logic 180 is also associated with allocation module 130. As discussed later, tracking logic 180, in one embodiment, assists in determining boundaries of a critical section from a “front-end” perspective.

Reorder/retirement unit 135 includes components, such as the reorder buffers mentioned above, load buffers, and store buffers, to support out-of-order execution and later in-order retirement of instructions executed out-of-order. In addition tracking logic 180 is also distributed in retirement logic 135. In one embodiment, tracking logic 180 determines boundaries for critical sections for a “back-end” perspective. Although tracking logic 180 is shown distributed through processor 100 and associated with allocation and retirement logic, tracking logic 180 is not so limited. In fact, tracking logic 180 may be located in one area, as well as associated with any portion of the front or back end of a processor pipeline. Furthermore, portions of tracking logic 180 may be included in cache 150, cache control logic, or higher level cache 110.

Scheduler and execution unit(s) block 140, in one embodiment, includes a scheduler unit to schedule instructions/operation on execution units. In fact, instructions/operations are potentially scheduled on execution units according to their type availability. For example, a floating point instruction is scheduled on a port of an execution unit that has an available floating point execution unit. Register files associated with the execution units are also included to store information instruction processing results. Exemplary execution units include a floating point execution unit, an integer execution unit, a jump execution unit, a load execution unit, a store execution unit, and other known execution units.

Note from above, that as illustrated, processor 100 is capable of executing at least four software threads. In addition, in one embodiment, processor 100 is capable of transactional execution. Transactional execution usually includes grouping a plurality of instructions or operations into a transaction, atomic section of code, or a critical section of code. In some cases, use of the word instruction refers to a macro-instruction which is made up of a plurality of operations. In a processor, a transaction is typically executed speculatively and committed upon the end of the transaction. A pendency of a transaction, as used herein, refers to a transaction that has begun execution and has not been committed or aborted, i.e. pending. Usually, while a transaction is still pending, locations loaded from and written to within a memory are tracked.

Upon successful validation of those memory locations, the transaction is committed and updates made during the transaction are made globally visible. However, if the transaction is invalidated during its pendency, the transaction is restarted without making the updates globally visible. Often, software demarcation is included in code to identify a transaction. For example, transactions may be grouped by instructions indicating a beginning of a transaction and an end of a transaction. However, transactional execution often utilizes programmers or compilers to insert the beginning and ending instructions for a transaction.

Therefore, in one embodiment, processor 100 is capable of hardware lock elision (HLE), where hardware is able to elide locks for critical sections and execute them simultaneously. Here, pre-compiled binaries without transactional support or newly compiled binaries utilizing lock programming are capable of benefiting from simultaneous execution through support of HLE. As a result of providing transparent compatibility, HLE often includes hardware to detect critical sections and to track memory accesses. In fact, since locks ensuring exclusion to data are elided, memory accesses may be tracked in a similar manner as during execution of transactions. Consequently, the hybrid pre-retire and post-retire access tracking scheme discussed herein may be utilized during transactional execution, HLE, another memory access tracking scheme, or a combination thereof. Therefore, discussion of execution of critical sections below potentially includes reference to a critical section of a transaction or a critical section detected by HLE.

In one embodiment, a memory device being accessed is utilized to track accesses from a critical section. For example, lower level data cache 150 is utilized to track accesses from critical sections; either associated with transactional execution or HLE. Cache 150 is to store recently accessed elements, such as data operands, which are potentially held in memory coherency states, such as modified, exclusive, shared, and invalid (MESI) states. Cache 150 may be organized as a fully associative, a set associative, a direct mapped, or other known cache organization. Although not illustrated, a D-TLB may be associated with cache 150 to store recent virtual/linear to physical address translations.

As illustrated, lines 151, 152, and 153 include portions and fields, such as portion 151a and field 151b. In one embodiment fields 151b, 152b, and 153b and portions 151a, 152a, and 153a are part of a same memory array making up lines 151, 152, and 153. In another embodiment, fields 151b, 152b, and 153b are part of a separate array to be accessed through separate dedicated ports from lines 151a, 152a, and 153a. However, even when fields 151b, 152b, and 153b are part of a separate array, fields 151b, 152b, and 153b are associated with portions 151a, 152a, and 153a, respectively. As a result, when referring to line 151 of cache 150, line 151 potentially includes portion 151a, 151b, or a combination thereof. For example, when loading from line 151, portion 151a may be loaded from. Additionally, when setting a tracking field to track a load from line 151, field 151b is accessed.

In one embodiment, lines, locations, blocks or words, such as lines 151a, 152a, and 153a are capable of storing multiple elements. An element refers to any instruction, operand, data operand, variable, or other grouping of logical values that is commonly stored in memory. As an example, cache line 151 stores four elements in portion 151a, such as four operands. The elements stored in cache line 151a may be in a packed or compressed state, as well as an uncompressed state. Moreover, elements may be stored in cache 150 aligned or unaligned with boundaries of lines, sets, or ways of cache 150. Memory 150 will be discussed in more detail in reference to the exemplary embodiments below.

Cache 150, as well as other features and devices in processor 100, store and/or operate on logic values. Often, the use of logic levels, logic values, or logical values is also referred to as 1's and 0's, which simply represents binary logic states. For example, a 1 refers to a high logic level and 0 refers to a low logic level. Other representations of values in computer systems have been used, such as decimal and hexadecimal representation of logical values or binary values. For example, take the decimal number 10, which is represented in binary values as 1010 and in hexadecimal as the letter A.

In the embodiment illustrated in FIG. 1, accesses to lines 151, 152, and 153 are tracked to support execution of critical sections. Accesses include operations, such as reads, writes, stores, loads, evictions, snoops, or other known accesses to memory locations. Access tracking fields, such as fields 151b, 152b, and 153b are utilized to track accesses to their corresponding memory lines. For example, memory line/portion 151a is associated with corresponding tracking field 151b. Here, access tracking field 151b is associated with and corresponds to cache line 151a, as tracking field 151b includes bits that are part of cache line 151. Association may be through physical placement, as illustrated, or other association, such as relating or mapping access tracking field 151b to memory line 151a or 151b in a hardware or software lookup table.

As a simplified illustrative example, assume access tracking fields 151b, 152b, and 153b include two transaction bits: a first read tracking bit and a second write tracking bit. In a default state, i.e. a first logical value, the first and second bits in access tracking fields 151b, 152b, and 153b represent that cache lines 151, 152, and 153, respectively, have not been accessed during execution of a critical section.

Assume a load operation to load from line 151a is encountered in a critical section. Utilizing a hybrid pre-retire and post-retire tracking scheme, the first read tracking bit is updated from the default state to a second accessed state, such as a second logical value. As discussed below, in a hybrid scheme, initiating the update to the first read tracking bit may be before the load operation retires, i.e. pre-retire, or after the operation retires, i.e. at retire or after retire. Here, the first read tracking bit holding the second logical value represents that a read/load from cache line 151 occurred during execution of the critical section. A store operation may be handled in a similar manner to update the first write tracking bit to indicate a store to a memory location occurred during execution of the critical section

Consequently, if the tracking bits in field 151b associated with line 151 are checked, and the transaction bits represent the default state, then cache line 151 has not been accessed during a pendency of a critical section. Inversely, if the first read tracking bit represents the second value, then cache line 151 has been previously read during execution of a critical section. Furthermore, if the first write tracking bit represents the second value, then a write to line 151 occurred during a pendency of the critical section.

Access fields 151b, 152b, and 153b are potentially used to support any type of transactional execution or HLE. In one embodiment, where processor 100 is capable of hardware transactional execution, access fields 151b, 152b, and 153b are set by pre-retire and post-retire accesses, as discussed below, to detect conflicts and perform validation. In another embodiment, where hardware transactional memory (HTM), software transactional memory (STM), or a hybrid thereof is utilized for transactional execution, access tracking fields 151b, 152b, and 153b provide a similar hybrid pre-retire and post-retire tracking function.

As a first example of how access fields, and specifically tracking bits, are potentially used to aid transactional execution, a co-pending application entitled, “Hardware Acceleration for A Software Transactional Memory System,” with Ser. No. 11/349,787 discloses use of access fields/transaction bits to accelerate a STM. As another example, extending/virtualizing transactional memory including storing states of access fields/transaction tracking bits into a second memory are discussed in co-pending application entitled, “Global Overflow Method for Virtualized Transactional Memory,” with serial number ______ and attorney docket number 042390.P23547.

In one embodiment, tracking logic 180 is to initiate a pre-retire access to update tracking fields associated with loads in critical sections. For example, assume a load operation in a critical section references line 151. By default, if a load operation within a critical section is detected, then a pre-retire access/update to tracking field 151b is to be performed. However, when a critical section is committed, successfully executed, or aborted access fields are reset to their default state to prepare for tracking of subsequent critical sections or a re-execution of an aborted critical section. However, in processors capable of out-of-order (OOO) execution, operations from subsequent critical sections may have already set tracking information in cache 150. Therefore, upon the reset of the access tracking fields, subsequent critical section tracking information may be lost. As a result, if the critical section including the load operation is a consecutive critical section, i.e. a subsequent critical section started before the end of a current critical section, then a post-retire of the load operation access is to be performed to update field 151b to ensure accurate tracking information.

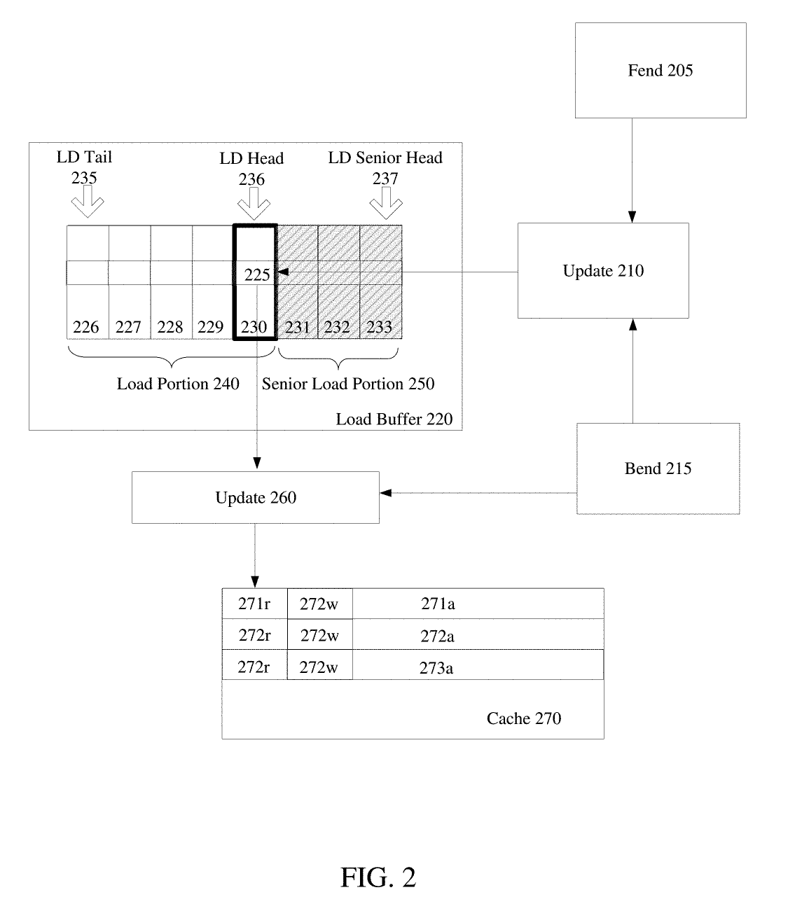

Turning to FIG. 2, an embodiment of tracking logic to initiate post-retire access field updates for consecutive critical sections is illustrated. As stated above, a transaction is often demarcated by start transaction and end transaction instructions, which allows for easy identification of critical sections. However, HLE includes detecting/identifying critical sections, eliding locks demarcating the critical sections, checkpointing register states for roll-back upon critical section abort, tracking tentative memory updates, and detecting potential data conflicts. One difficulty in detecting/identifying critical sections is delineating between regular lock instructions and lock/lock release instructions that demarcate a critical section.

In one embodiment, for HLE a critical section is defined by a lock instruction, i.e. a start critical section instruction, and a matching lock release instruction, i.e. and end critical section instruction. A lock instruction may include a load from an address location, i.e. checking if the lock is available, and a modify/write to the address location, i.e. an update to the address location to set the lock. A few examples of instructions that may be used as lock instructions include, a compare and exchange instruction, a bit test and set instruction, and an exchange and add instruction. In Intel's IA-32 and IA-64 instruction set, the aforementioned instructions include CMPXCHG, BTS, and XADD, as described in Intel® 64 and IA-32 instruction set documents discussed above.

As an example, where predetermined instructions, such as CMPXCHG, BTS, and XADD are detected/recognized, detection logic and/or decode logic detects the instructions utilizing an opcode field or other field of the instruction. As an example, CMPXCHG is associated with the following opcodes: OF B0/r, REX+0F B0/r, and REX.W+0F B1/r. In another embodiment, operations associated with an instruction are utilized to detect a lock instruction. For example, in ×86 the following three memory micro-operations are often used to perform an atomic memory update indicating a potential lock instruction: (1) Load_Store_Intent (L_S_I) with opcode 0x63; (2) STA with opcode 0x76; and (3) STD with opcode 0x7F. Here, L_S_I obtains the memory location in exclusive ownership state and does a read of the memory location, while the STA and STD operations modify and write to the memory location. In other words, detection logic is searching for a load with store intent (L_S_I) to define the beginning of a critical section. Note that lock instructions may have any number of other non-memory, as well as other memory, operations associated with the read, write, modify memory operations.

Although not illustrated in FIG. 2, often a stack, such as a lock stack, is utilized to hold an entry associated with a lock instruction when detected. The lock instruction entry (LIE) may include any number of fields to store critical section related information, such as a lock instruction store physical address (LI Str PA), a lock instruction load value and load size, a lock instruction store value and size, a micro-operation count, a release flag, a late lock acquire flag, and a last instruction pointer field.

Here, a lock release instruction corresponding to the lock instruction demarcates the end of a critical section. Detection logic searches for a lock release instruction that corresponds to the address modified by the lock instruction. Note that the address modified by the lock instruction may be held in a Lock Instruction Entry (LIE) on the lock stack. As a result, in one embodiment, a lock release instruction includes any store operation that sets the address modified by the corresponding lock instruction back to an unlocked value. An address referenced by an L_S_I instruction that is stored in the lock stack is compared against subsequent store instructions to detect a corresponding lock release instruction. More information on detecting and predicting critical sections may be found in a co-pending application entitled, “A CRITICAL SECTION DETECTION AND PREDICTION MECHANISM FOR HARDWARE LOCK ELISION,” with application Ser. No. 11/599,009.

In other words, with HLE a critical section is demarcated by an L_S_I instruction and a corresponding lock release instruction. Similarly, a critical section of a transaction is defined by a start transaction instruction and an end transaction instruction. Therefore, reference to a start critical section operation/instruction includes any instruction starting an HLE, transactional memory, or other critical section, while reference to an end critical section operation/instruction includes starting an HLE, transactional memory, or other critical section ending instructions.

Fend 205 is to hold a front-end count to indicate when execution is within a critical section. In one embodiment, fend 205 includes a front-end counter. As an example, the front-end counter is initialized to a default value of zero. In response to detecting a start critical section instruction the front-end counter is incremented, and in response to detecting an end critical section instruction the front-end counter is decremented. As an illustration, assume an L_S_I instruction is detected. Upon allocation of the instruction, such as upon allocation of the load, fend 205 is incremented to one. As a result, subsequent instructions, when allocated, are assumed to be within a critical section, since fend 205 includes a non-zero value of one.

In one embodiment fend 205 also provides nesting depth of critical sections. Here, if multiple start critical section operations are allocated, then fend 205 is incremented, accordingly, to represent the nesting depth of critical sections. For example, assume there is a first critical section nested within a second critical section, which is nested within a third critical section. Consequently, fend 205 is incremented to one upon allocating the third critical section's L_S_I, incremented to two upon allocating the second critical section's L_S_I, and incremented to three upon allocating the first critical section's L_S_I. Furthermore, in response to retiring a lock release instruction, i.e. a corresponding store operation, fend 205 is decremented.

Therefore, in response to retiring the first critical section's store operation to perform a lock release fend 205 is decremented to two and so forth until the third critical section's lock release decremented fend 205 to zero. Here, subsequent instructions/operations are assumed not to be within a critical section, as fend 205 holds a zero value. Note that, in one embodiment, a value of Fend 205 is to be checkpointed before a branch, as the value of Fend 205 may need to be recovered due to a mispredicted path, i.e. a branch misprediction.

In one embodiment, an access buffer, such as a load buffer or store buffer, is to hold access entries associated with memory access operations. Each access buffer entry includes a tracking field portion and/or memory update field. By default the memory update field is to hold a first value, such as a logical zero, to indicate no pre-retire access tracking is to be performed. However, when fend 205 is non-zero indicating an operation is within a critical section, the memory update field is updated to a second value, such as a logical one, to indicate a pre-retire access to update an access tracking field is to be performed.

Although load buffer 220 is illustrated in FIG. 2, any access buffer, such as a store buffer may operate in a similar manner. Therefore, load buffer 220 will be discussed in detail below to illustrate exemplary operation of an access buffer. Load buffer 220 includes a plurality of load buffer entries, such as entries 226-233. When a load operation is encountered, a load buffer entry is created/stored in load buffer 220. In one embodiment, load buffer 220 stores load buffer entries in program order, i.e. an order the instructions or operations are ordered in the program code. Here, youngest load buffer entry 226, i.e. the most recently stored load buffer entry, is referenced by load tail pointer 235. In contrast, oldest load buffer entry 230, which is not a senior load, is referenced by load head pointer 236.

In an in-order execution processing element, load operations are executed in the program order stored in the load buffer. As a result, the oldest buffer entries are executed first, and load head pointer 236 is re-directed to the next oldest entry, such as entry 229. In contrast, in an out-of-order machine, operations are executed in any order, as scheduled. However, entries are typically removed, i.e. de-allocated from the load buffer, in program order. As a result, load head pointer 236 and load tail pointer 235 operate in similar manner between the two types of execution.

In one embodiment, each load buffer entry, such as entry 230, includes memory update field 225, which may also be referred to as a tracking field, a set cache bit field, and an update transaction bit field. Load buffer entry 230 may include any type of information, such as the memory update value, a pointer value, a reference to an associated load operation, a reference to an address associated with the load operation, a value loaded from an address, and other associated load buffer values, flags, or references.

As an example, assume a load operation associated with load entry 230 references a system memory address. Whether originally owned and located in cache line 271a or fetched in response to a miss to cache 270, assume the element referenced by the system memory address currently resides in cache line 271a. As a result, when cache line 271a is loaded from during execution of a critical section, read tracking bit 271r is to be updated to indicate associated cache line 271a has been accessed during a pendency of the critical section.

When the load operation is allocated, memory update field 225 is updated based on a value of fend 205. In response to fend 205 holding a zero value to indicate the load operation is not within a critical section, update field 225 is updated to a logical zero to indicate no pre-retire access to tracking bit 271r is to be made. Note that updating a bit, a value, or a field does not necessarily indicate a change to the bit, value or the field. For example, if field 225 is already set to a logical zero, then updating to a logical zero potentially includes re-writing a logical zero to field 225, as well as no action to leave field 225 holding a logical zero.

In contrast to the scenario discussed above, if fend 205 holds a non-zero value upon allocation of the load operation, then field 225 is set to a pre-retire value, such as a logical one, to indicate a pre-retire access to tracking bit 271r is to be performed. In one embodiment, update logic 210 is to update field 225 upon allocation of the load operation associated with entry 230. As an example, update logic 210 includes a register or other logic to read/hold a current value from fend 205 and logic to update field 225 in entry 230. Here, a pre-retire access includes any access to update read tracking bit 271r before retirement of the load operation associated with entry 230. In one embodiment, when field 225 holds the pre-retire value; an update to bit 271r is initiated in response to a dispatch of the load operation associated with entry 230. In other words, when a load associated with entry 230 is dispatched, an access to update bit 271r is scheduled if field 225 holds a pre-retire value. In contrast, if field 225 holds a non-pre retire value, such as a logical zero, then no access is schedule upon dispatch.

However, in an out-of-order execution processor, instructions/operations may be executed out-of-order. In one instance, a subsequent non-critical section load may be allocated before an end of the current critical section instruction is retired to decrement fend 205. As a result, the load buffer entry associated with the non-critical section load includes a pre-retire value, which leads to spurious access tracking, i.e. tracking the load in the cache even though it is not within a critical section. However, spurious access tracking does not lead to incorrect data, and may rarely result in spurious aborts due to incorrect data contention detection.

Alternatively, assume a load from a subsequent critical section is allocated before the retirement of the ending instruction from the current critical section. The load buffer entry associated with the load would hold a pre-retire value. However, if the ending instruction is now retired before the load is dispatched, the update tracking fields in the load buffer including the associated load buffer entry holding the pre-retire value are reset. Consequently, upon dispatch of the load no pre-retire access is scheduled. Here, another processing element may update the loaded location and no data conflict is detected, because the access tracking fields have not tracked an access.

Therefore, upon retiring a load operation, if memory update field 225 of load buffer entry 230, which is associated with the load operation, includes a reset value, such as a logical zero, then back-end (Bend) logic 215 is checked. Bend 215 operates in a similar manner to Fend 205, except for Bend 215 is incremented when a start critical section instruction is retired, instead of allocated as for Fend 205. Additionally, Bend 215 is decremented in response to retiring an end critical section operation. If Bend holds a non-zero value indicating execution within a critical section and field 225 holds a reset value, as discussed above, then a post-retire access to cache 270 to update read tracking bit 271r is scheduled.

Figure A includes a simplified illustrative embodiment of consecutive critical sections. Note that operations/access, allocations, and dispatches of instructions/operation have been omitted to simplify the example, and that these operation may occur in any order. At time 1 (t1), a start critical section 1 instruction/operation is allocated. In response fend 205 is incremented to one. Next, at t2 the start critical section operation is retired, which increments Bend 215 to one. At t3, a start critical section two operation is allocated resulting in Fend 205 to be incremented to two. Next, a load from critical section two is allocated at time t4, which is to load from line 271a of cache 270. Since Fend 205 holds a value of two, i.e. a non-zero value, update logic 210 sets access tracking field 225 in load buffer entry 230 to a pre-retire value of a logical one. Note that load buffer entry 230 is associated with the load from critical section two.

At t5, although allocation was not illustrated, an end critical section one operation is retired, which results in Fend 205 being decremented to one and Bend 215 being decremented to zero. In response to Bend 215 being decremented to zero, access tracking field 225 is reset to zero. The load from critical section two is dispatched at t6; however, the update/access tracking field holds a zero, so no pre-retire access to cache 270 is scheduled. As a result, bit 271r remains in a default state indicating no access during critical section two. At t7, the start critical section two operation is retired, which increments Bend 215 to one.

In addition, at t8 the load from critical section two is retired. Here, update field 225 holds a value of zero and Bend 215 holds a non-zero value, i.e. a one. As a result of those conditions taken by update logic 260, a post-retire access to cache 270 is scheduled. Bit 271r is updated to indicate an access to line 271a has occurred during execution of critical section two. As can be seen, the potential of not tracking loads from consecutive critical sections may be avoided by implementing a hybrid pre-retire and post-retire system. Therefore, in one embodiment, pre-retire updates are performed for critical section memory accesses, except for a subsequent consecutive critical section, where post-retire updates are performed. In the example above, consecutive critical sections are determined from memory update field 225 holding a zero value and Bend 215 holding a non-zero value. In other words, consecutive critical sections, in one embodiment, are where an end of a first critical section operation is not retired before a start of a second critical section operation is allocated. Here, there may be a few or many non-transactional operations allocated and/or executed between critical sections. However, any method for detecting/determining consecutive critical sections may be utilized.

Post-retire accesses to update access tracking fields may be performed in any manner. In one embodiment, access buffers are capable of holding senior accesses to allow for post-retire accesses. As illustrated in FIG. 2, load buffer 220 includes senior load portion 250 for holding senior load buffer entries 231-233. When a load is retired, such as a load associated with load buffer entry 230, load head pointer 236 is directed at next oldest entry 229, and entry 230 becomes part of senior load portion 250. If a senior load buffer entry is not designated for a post-retire update, i.e. a pre-retire access was performed as designated by field 225 holding a pre-retire value or the access was not within a critical section, then it may be immediately de-allocated from load buffer 220. However, when entry 230 is pointed to by load senior head pointer 237, then a post-retire access is scheduled by a scheduler to update read tracking field 271r. A co-pending application entitled, “A POST-RETIRE SCHEME FOR TRACKING TENTATIVE ACCESSES DURING TRANSACTIONAL EXECUTION,” with application Ser. No. 11/517,029 discusses in more detail senior access buffer entries and post-retire access for tracking tentative memory accesses.

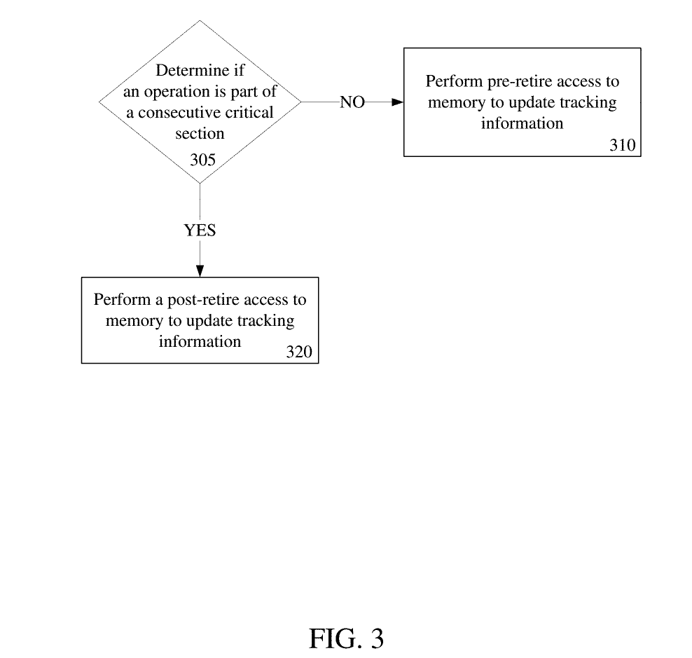

Referring next to FIG. 3, an embodiment of a flow diagram for a method of performing hybrid pre and post retire updates for tracking tentative accesses is illustrated. In flow 305, it is determined if an operation is part of a consecutive critical section. In one embodiment, the critical section is a transactional memory critical section. In another embodiment, the critical section is an HLE detected critical section. As stated above, a consecutive critical section, in one embodiment, includes a critical section's start critical section operation allocated before another pending critical section's end critical section is retired. As an example, the allocation and retirement are determined from counters, such as a front-end counter and back-end counter, as described above. Consequently, consecutive critical sections may immediately follow each other in code, or in contrast, there may be non-transactional operations between consecutive critical sections.

If the operation is part of a non-consecutive critical section, then in flow 310 a pre-retire access to memory to update tracking information is performed. In one embodiment, tracking information includes read and write bits/fields to indicate whether reads and writes, respectively, have occurred during a pendency of the critical section. As an example, upon dispatch of the operation an access to a memory is scheduled to update read and write bits/fields.

In contrast, if the operation is part of a consecutive critical section, then in flow 320 a post-retire access to memory to update the tracking information is performed. In other words, if a previous critical section's end critical section operation has not been retired and a current consecutive critical section's start transaction operation has been allocated, then when the previous end critical section is retired, the pre-retire tracking data for the current consecutive critical section may be reset or otherwise affected. Therefore, in this example, consecutive critical section memory accesses are tracked post-retire. In one embodiment, upon retirement of the operation, an access buffer entry associated with the operation is made a senior access buffer entry. In response to the operation becoming a senior access, an update to the tracking information is scheduled post-retirement of the operation.

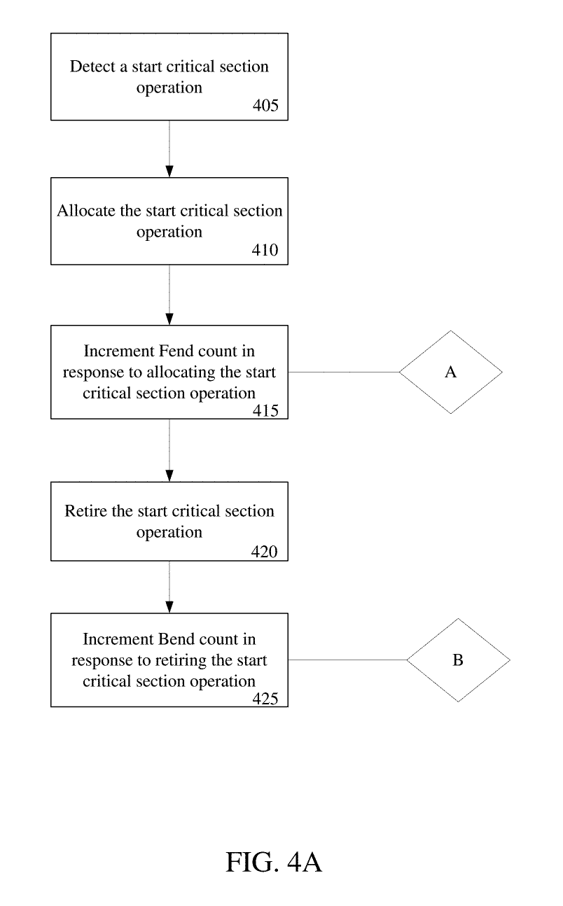

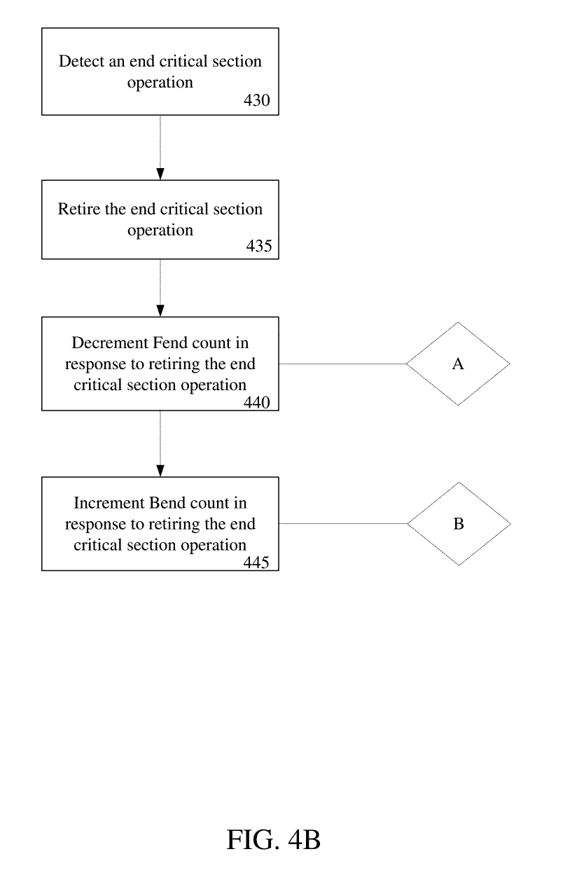

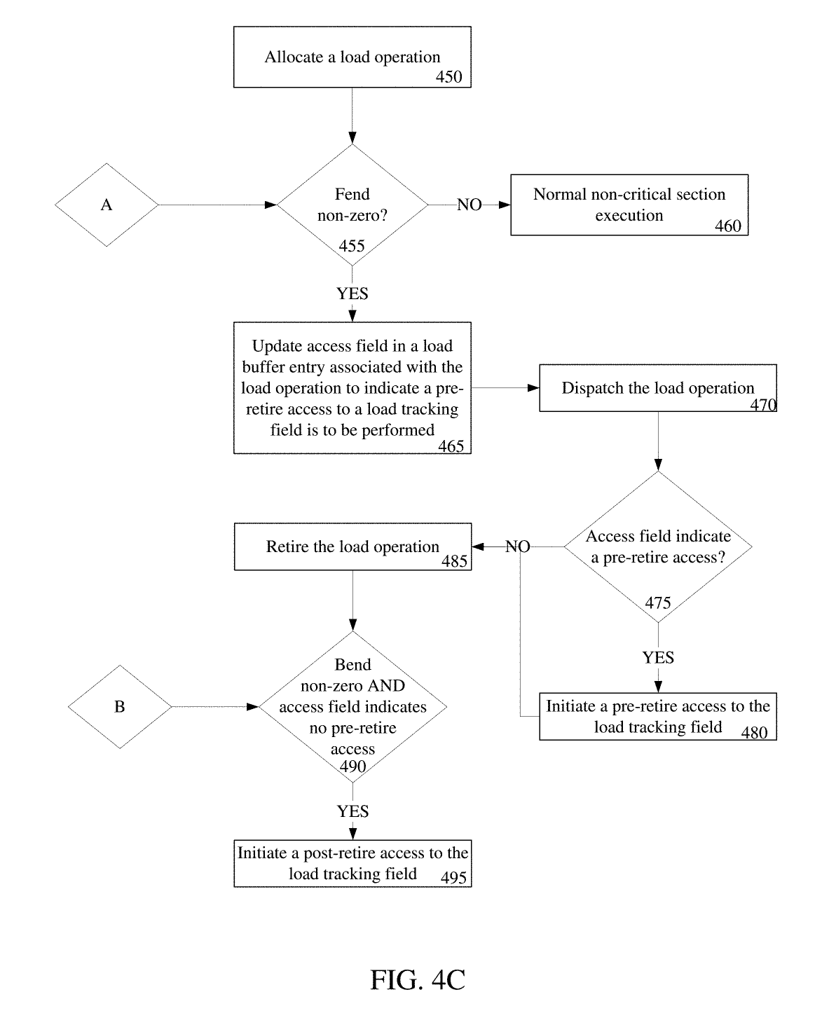

FIGS. 4a-4c illustrate embodiments of flow diagrams for a method of performing hybrid pre and post retire access tracking. Referring to FIG. 4a, in flow 405 a start of a critical section operation is detected. In one embodiment, the start critical section operation is a Load with Store Intention (L_S_I) operation. An example of detection and prediction of critical sections is discussed in co-pending application with Ser. No. 11/599,009, as discussed above.

In another embodiment, the start critical section operation includes a start transaction operation. Often a compiler inserts start transaction operations. For example, a start transaction function call may be placed before a critical section to perform specific transaction functions, such as checkpointing, validation, and logging. Next in flow 410, the start critical section operation is allocated. Note that more than one start critical section operation may be included and allocated. Continuing the example above, the L_S_I operation is allocated.

In flow 415 fend count is incremented in response to allocating the start critical section operation. Note the flow diagram branches to decision flow A from flow 415. This is to illustrate in later figures that the fend count variable is utilized as input into other decisions in the flow. Although flow 415 influences the value of fend count through incrementing, other flows, such as flow 440 from FIG. 4b, also influence the value of fend count.

At some point later, after dispatch, the start critical section operation is retired at flow 420. For example, if the start critical section operation is an L_S_I, the load entry is retired and potentially later de-allocated from a load buffer. In flow 425, a Bend count is incremented in response to retiring the start critical section operation. Similar to decision flow A, decision flow B takes incrementing of Bend as an input.

Referring next to FIG. 4b, in flow 430, an end critical section operation is detected at flow 430 and retired at flow 435. In one embodiment, the end critical section operation is a corresponding store operation to update a lock value to unlocked. In another embodiment, the end critical section operation is an end transaction instruction/operation. Similar to a start transaction instruction, a compiler may insert operations to perform various tasks, such as validation, roll-back, and commitment.

In flows 440 and 445 both Fend and Bend are decremented in response to retiring the end critical section operation. Here, with an HLE critical section, address compare may be required, as referred to above, to determine a HLE end of critical section operation. Often, an address is not available upon allocation of the operation, so even though in one embodiment, Fend may be decremented upon allocation of an end critical section operation; here, Fend is also decremented at retire of an end critical section operation. As stated above, the decrementing of Fend and Bend are taken as inputs into decision flows A and B, respectively. Although not illustrated, an update access field, which is discussed in more detail in reference to FIG. 4c, may be reset, cleared, or updated in response to Bend being decremented to zero.

Turning to FIG. 4c, a load operation is allocated in flow 450. In flow 455 it is determined if Fend is non-zero. Decision flow A from FIGS. 4a and 4b are input into flow 455. If Fend holds a zero value, then normal non-critical section execution continues in flow 460. Otherwise, if Fend is incremented by start critical section operations and not decremented to zero by end critical section operations, then it is assumed that the load operation is within an executing critical section. Here, an access field, update tracking field, or other field in a load buffer entry associated with the load operation is updated to indicate a pre-retire access to a load tracking field is to be performed in flow 465.

In flow 470, the load is dispatched. If the access field was set to a pre-retire access value in flow 465, as determined in decision flow 475, then a pre-retire access to the load tracking field is initiated in flow 480. In one embodiment, a scheduler schedules an access based on the access field holding a pre-retire value upon dispatch of an associated load operation. Either after the pre-retire access is initiated or after decision flow 475 directly, the load operation is to retire at flow 485.

In response to retiring the load operation, it is determined if Bend is non-zero and the access field indicates no pre-retire access in flow 490. Note that decision flow B is an input into flow 490. If Bend is non-zero and the access field indicates no pre-retire access, then in flow 495 a post-retire updated to the load tracking field is initiated. Otherwise, execution continues as normal.

As illustrated above, pre-retire access tracking may be performed for a majority of critical sections. However, to ensure valid access tracking, post-retire updates may be performed for consecutive critical sections. Therefore, by performing a majority of pre-retire updates, power may be saved by not having to access a cache twice, i.e. once for an access and once for an update of tracking information. However, the accuracy of the data tracking is maintained through use of some post-retire updates to the tracking information.

The embodiments of methods, software, firmware or code set forth above may be implemented via instructions or code stored on a machine-accessible or machine readable medium which are executable by a processing element. A machine-accessible/readable medium includes any mechanism that provides (i.e., stores and/or transmits) information in a form readable by a machine, such as a computer or electronic system. For example, a machine-accessible medium includes random-access memory (RAM), such as static RAM (SRAM) or dynamic RAM (DRAM); read-only memory (ROM); magnetic or optical storage medium; and flash memory devices. As another example, a machine-accessible/readable medium includes any mechanism that receives, copies, stores, transmits, or otherwise manipulates electrical, optical, acoustical or other form of propagated signals (e.g., carrier waves, infrared signals, digital signals); etc including the embodiments of methods, software, firmware or code set forth above.

Reference throughout this specification to “one embodiment” or “an embodiment” means that a particular feature, structure, or characteristic described in connection with the embodiment is included in one embodiment of the present invention and is not required to be present in all discussed embodiments. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In the foregoing specification, a detailed description has been given with reference to specific exemplary embodiments. It will, however, be evident that various modifications and changes may be made thereto without departing from the broader spirit and scope of the invention as set forth in the appended claims. The specification and drawings are, accordingly, to be regarded in an illustrative sense rather than a restrictive sense. Furthermore, the foregoing use of embodiment and other exemplarily language does not necessarily refer to the same embodiment or the same example, but may refer to different and distinct embodiments, as well as potentially the same embodiment.

What is claimed is:

1. An apparatus comprising:
a processing element to execute a non-critical section of code and a critical section of code;
a memory to be associated with the processing element, wherein a line of the memory is to be associated with a tracking field, and wherein the critical section of code is to include an operation to reference the line;
tracking logic associated with the memory, which in response to the critical section of code being a subsequent consecutive critical section of code, is to initiate a post-retire of the operation update to the tracking field to indicate an access to the line occurred during execution of the critical section and, in response to the critical section of code not being a subsequent consecutive critical section of code, to initiate a pre-retire of the operation update of the tracking field to indicate an access to the line occurred during execution of the critical section of code.

2. The apparatus of claim 1, wherein the tracking logic includes front-end tracking logic to determine the operation is included in the critical section of code.

3. The apparatus of claim 2, wherein front-end tracking logic includes a front-end counter, the front-end counter to be incremented responsive to allocating a start of the critical section operation, and wherein the operation is determined to be included in the critical section of code responsive to the front-end counter holding a value greater than a predetermined value of the front-end counter.

4. The apparatus of claim 3, wherein the front-end counter is to be decremented responsive to retiring an end of the critical section operation, and wherein the start of the critical section operation includes a load with intention to store (L_S_I) operation and the end of the critical section operation includes a store operation that references an address corresponding to the L_S_I operation.

5. The apparatus of claim 3, wherein the front-end counter is to be decremented responsive to allocating an end of the critical section operation, and wherein the start of the critical section operation includes start transaction operation and the end of the critical section operation includes an end transaction operation.

6. The apparatus of claim 3, wherein the tracking logic further includes a back-end counter to be incremented responsive to retiring the start of the critical section operation and to be decremented responsive to retiring the end of the critical section operation.

7. The apparatus of claim 6, further comprising an access buffer capable of holding senior access entries, the access buffer to include an access entry corresponding to the operation, wherein the access entry includes a tracking field portion.

8. The apparatus of claim 7, wherein the operation is a load operation, the access buffer includes a load buffer capable of holding senior load entries, and the access entry includes a load entry corresponding to the load operation.

9. The apparatus of claim 7, further comprising update logic coupled to the front-end counter and to the access buffer, the update logic to update the tracking field portion of the access entry to indicate a pre-retire of the operation update to the tracking field is to be initiated responsive to the front-end counter holding a value greater than the default value upon allocation of the operation.

10. The apparatus of claim 9, wherein the update logic is also coupled to the back-end counter, the update logic to reset the tracking field portion of the access entry to indicate no pre-retire of the operation update to the tracking field is to be initiated responsive to the back-end counter being decremented to a default value.

11. The apparatus of claim 10, wherein the tracking logic, in response to the critical section of code being a subsequent consecutive critical section of code, to initiate a post-retire of the operation update to the tracking field to indicate an access to the line occurred during execution of the critical section comprises the tracking logic, in response to the tracking field portion of the access entry being reset and the back-end counter holding a value greater than the default value, is to initiate the post-retire of the operation update to the tracking field.

12. A system comprising:
an integrated circuit including:
an execution unit capable of executing a critical section (CS) of code, the CS to include a load operation referencing an address, wherein the CS is to be demarcated by a start CS operation and an end CS operation;
a memory coupled to the execution unit, the memory to include a memory line to be associated with the address, wherein a load tracking field is to be associated with the memory line;
critical section logic associated with the execution unit to determine if the critical section is a consecutive critical section; and
a load buffer coupled to the critical section logic to hold a load entry to be associated with the load operation, wherein the load entry is to include a memory update field to hold a first value to indicate a pre-retire update to the load tracking field is to be performed in response to the critical section logic determining the critical section is not a consecutive critical section and to hold a second value to indicate a post-retire update to the load tracking field is to be performed in response to the critical section logic determining the critical section is a consecutive critical section; and
a higher-level memory coupled to the integrated to store an element at a memory location associated with the address.

13. The system of claim 12, wherein the critical section logic includes:
a first counter to be incremented in response to detecting the start CS operation and to be decremented in response to retiring the end CS operation;
a second counter to be incremented in response to retiring the start CS operation and to be decremented in response to retiring the end CS operation.

14. The system of claim 13, wherein the memory update field is to be set to the first value in response to detecting the load operation when the first counter holds a non-zero value, and wherein the memory update field is to be reset to the second value in response to the second counter being decremented to a value of zero.

15. The system of claim 14, wherein critical section logic to determine if the critical section is a consecutive critical section comprises determining the critical section is a consecutive critical section in response to the memory update field holding the second value and the second counter holding a non-zero value.

16. The system of claim 15, wherein the start CS operation is an operation selected from a group consisting of a start transaction operation, a load with intent to store (L_S_I) operation, and a combination load and store operation, and wherein the end CS operation is selected from a group consisting of an end transaction operation, a store operation corresponding to a previous L_S_I operation, and a combination arithmetic and store operation.

17. The system of claim 15, wherein the load buffer is capable of holding senior load entries, and wherein a post-retire update to the memory line is to be performed when the load entry is referenced as a head senior load entry in the load buffer.

18. The system of claim 15, wherein the pre-retire and the post-retire updates to the load tracking field is to update the tracking field to indicate a load from the memory line occurred during execution of the critical section.

19. A method comprising:
performing a pre-retire update to a first access tracking field to indicate an access to a first line of memory, which is associated with the first access tracking field, has been accessed during execution of a first pending critical section; and
performing a post-retire update to a second access tracking field to indicate an access to a second line of memory, which is associated with the second access tracking field, has been accessed during execution of a second pending critical section.

20. The method of claim 19, further comprising determining the first pending critical section is a non-consecutive pending critical section and determining the second pending critical section is a consecutive pending critical section.

21. The method of claim 20, wherein determining the first pending critical section is a non-consecutive pending critical section comprises:
incrementing a front-end count responsive to allocating a begin critical section operation;
decrementing the front-end count responsive to retiring an end critical section operation;
updating a field in an access buffer entry, which corresponds to an access associated with the first line of memory, to a pre-retire value in response to the front-end count representing a non-zero value upon allocating the access; and
determining the first pending critical section is a non-consecutive critical section in response to the field in the access buffer entry holding the pre-retire value upon retirement of the access.

22. The method of claim 21, wherein the field in the first access buffer entry holding the first value is to indicate the pre-retire update to the first access tracking field is to be performed in response to dispatching the first access

23. The method of claim 20, wherein determining the second pending critical section is a consecutive pending critical section comprises incrementing a back-end count responsive to retiring a begin critical section operation;
decrementing the back-end count responsive to retiring an end critical section operation;
updating a field in an access buffer entry, which corresponds to an access associated with the second line of memory, to a non-access value in response to the back-end count decrementing to zero; and
determining the second pending critical section is a consecutive critical section in response to the field in the access buffer entry holding the non-access value upon retirement of the access and the back-end count holding a non-zero value.
